(19) United States
(12) Patent Application Publication
(10) Pub. No.: US 2006/0211301 A1
(43) Pub. Date: Sep. 21, 2006

(54) Snap-on faceplate attachment

(75) Inventors: Jerry B. Bodily, Colorado Springs, CO (US); Shivanand Shivalli, Colorado Springs, CO (US); Justin Lotak, Colorado Springs, CO (US)

Correspondence Address: MICHAEL BEST & FRIEDRICH, LLP, 100 E WISCONSIN AVENUE, MILWAUKEE, WI, 53202, US

(73) Assignee: Schlage Lock Company, Carmel, IN (US)

(21) Appl. No.: 11/385,118

(22) Filed: Mar. 21, 2006

Related U.S. Application Data
(60) Provisional application No. 60/663,671, filed on Mar. 21, 2005.

(51) Int. Cl. H01R 13/66

(52) U.S. Cl. 439/536

(57) ABSTRACT

A faceplate for a door latch assembly that includes a housing having a first snap member and a latch disposed within the housing. The faceplate includes a first major surface, a second major surface oppositely positioned from the first major surface, and side portions disposed adjacent the first and second major surfaces. An aperture is disposed laterally through the first and second major surfaces and configured to allow the latch to extend laterally through the faceplate. The faceplate further includes a second snap member that couples with the first snap member and attaches the faceplate to the housing without the use of a tool.

### CROSS-REFERENCE TO RELATED APPLICATION

This application claims the benefit of U.S. Provisional Patent Application No. 60/663,671, filed Mar. 21, 2005. The entire content of this application is hereby incorporated by reference.

### BACKGROUND

The present invention relates to attachment of a faceplate to a door latch or auxiliary lock assembly. More particularly, the present invention relates to a faceplate that attaches to the door latch assembly without the use of tools.

Existing door latch assemblies are mounted in a door and include a housing that supports a deadbolt or other latch and a decorative faceplate attached to the housing by screws or other tool-driven fasteners. Some door latch assemblies have backplates permanently attached to the housing by staking or resistance welding. This requires the faceplate to match to the backplate and limits the available options for the faceplate. Attachment and removal of the faceplate from the backplate requires the use of a screw driver or other specialized assembly equipment that often damages the backplate and the faceplate due to the variable force required.

Securing the faceplate to the backplate using tool-driven fasteners limits the ability to properly align the decorative faceplate with an outer surface of the door. Aligning the faceplate to be flush with the surface is often painstaking and difficult to accomplish using the tool-driven fasteners. This sometimes requires several trial fits of the faceplate before proper alignment is attained, thereby raising installation costs and increasing the opportunity for improper alignment and other installation defects.

Typically, door latch assemblies are designed for a specific faceplate attachment and do not allow interchangeability with other faceplate attachments. Often, the entire latch assembly must be replaced to attach a different decorative faceplate because the backplate does not match the desired faceplate. Changing the faceplate damages welded or staked backplates as well as doors during removal, and requires complex and costly tooling that raises installation costs.

In some assemblies, structural support for the deadbolt cannot be facilitated by the faceplate because the faceplate is merely decorative. This places increased stress on the deadbolt and causes potential misalignment of the deadbolt with a strike plate disposed in a door frame and weakens the door latch assembly. This may further result in rattling or even jamming of the deadbolt when the door latch assembly is operated.

### SUMMARY

In one embodiment, the invention provides a plate for a door latch assembly that includes a housing and a bolt disposed within the housing. The plate includes a plate member having a first major surface, a second major surface oppositely positioned from the first major surface, and side portions. The plate further includes an aperture disposed laterally through the first and second major surfaces. The aperture is configured to allow the bolt to extend laterally through the plate member. A snap member disposed on the plate is configured to attach the plate to the housing without the use of a tool.

In another embodiment the invention provides a door latch assembly installed in a door. The door latch assembly includes a housing, a faceplate, and a latch. The housing defines a space and includes a first snap member. The latch is at least partially disposed within the space. The faceplate includes a second snap member and an aperture to receive a portion of the latch. The faceplate is coupled to the housing through the first and second snap members without the use of a tool.

In another embodiment the invention provides a method of attaching a plate for a door latch assembly having a housing and a bolt disposed within the housing and installed in a door. The method includes aligning an opening of the plate with an axis defined by the housing and attaching the plate to the housing without using a tool.

Other aspects of the invention will become apparent by consideration of the detailed description and accompanying drawings.

### BRIEF DESCRIPTION OF THE DRAWINGS

FIG. 1 is a perspective view of a door latch assembly, including a deadbolt, a housing, and a faceplate;

FIG. 2 is a side view of the housing of FIG. 1;

FIG. 3 is a is a front view of the faceplate of FIG. 1;

FIG. 4 is a front view of another embodiment of the faceplate of FIG. 1;

FIG. 5 is a section view of the faceplate taken along line 5-5 of FIG. 3;

FIG. 6 is a section view of the faceplate taken along line 6-6 of FIG. 3;

FIG. 7 is a perspective view of another embodiment of a door latch assembly, including a housing and a faceplate;

FIG. 8 is a top view of the faceplate of FIG. 7;

FIG. 9 is a front view of the faceplate of FIG. 7;

FIG. 10 is a side view of the faceplate of FIG. 7;

FIG. 11 is a section view taken along line 11-11 of FIG. 8;

FIG. 12 is a perspective view of another embodiment of a door latch assembly, including a housing, a backplate, and a faceplate;

FIG. 13 is a front view of the backplate of FIG. 12;

FIG. 14 is a rear view of the backplate of FIG. 12;

FIG. 15 is a section view of the backplate taken along line 15-15 of FIG. 14;

FIG. 16 is a section view of the backplate taken along line 16-16 of FIG. 14;

FIG. 17 is a section view of the backplate taken along line 17-17 of FIG. 14;

FIG. 18 is a front view of the faceplate of FIG. 12;

FIG. 19 is a rear view of the faceplate of FIG. 12;

FIG. 20 is a section view of the faceplate taken along line 20-20 of FIG. 18;

FIG. 21 is a section view of the faceplate taken along line 21-21 of FIG. 18; and

FIG. 22 is a perspective view of another embodiment of a door lock assembly, including a housing, a backplate, and a faceplate.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

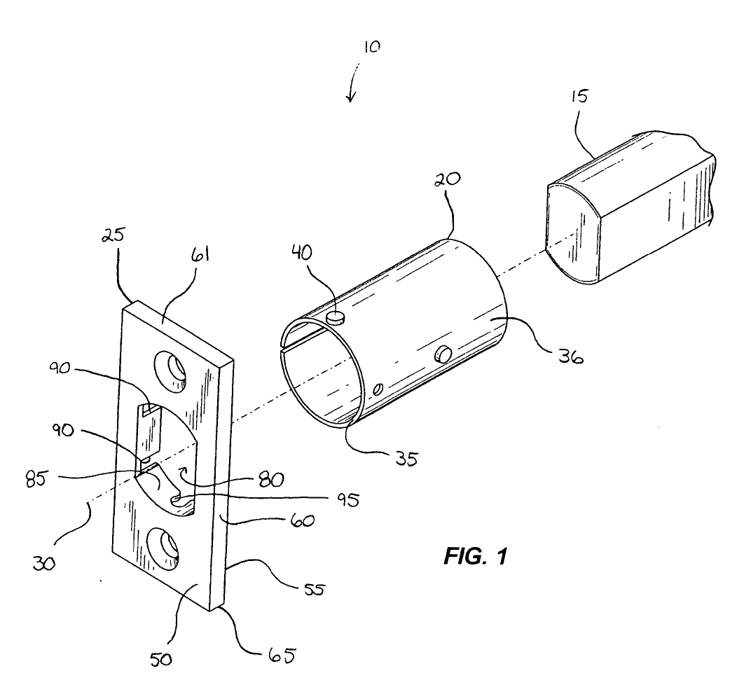

FIG. 1 shows a portion of a door latch assembly 10 that can be mounted in a cylindrical opening of a door (not shown). The door latch assembly 10 is configured to secure the door to a door frame (not shown), and includes a deadbolt or latch 15, a housing 20, and a plate or faceplate 25. The latch 15 is mounted for mechanical retraction and spring extension, and extends into and is withdrawn from a strike box (not shown) installed in the door frame. A first end of the latch 15 is disposed within the housing 20 and a second end protrudes from the housing 20, through the faceplate 25, and into the strike box along an axis 30 of the housing 20. The latch 15 is a latch or deadbolt that is commonly used in door latch assemblies.

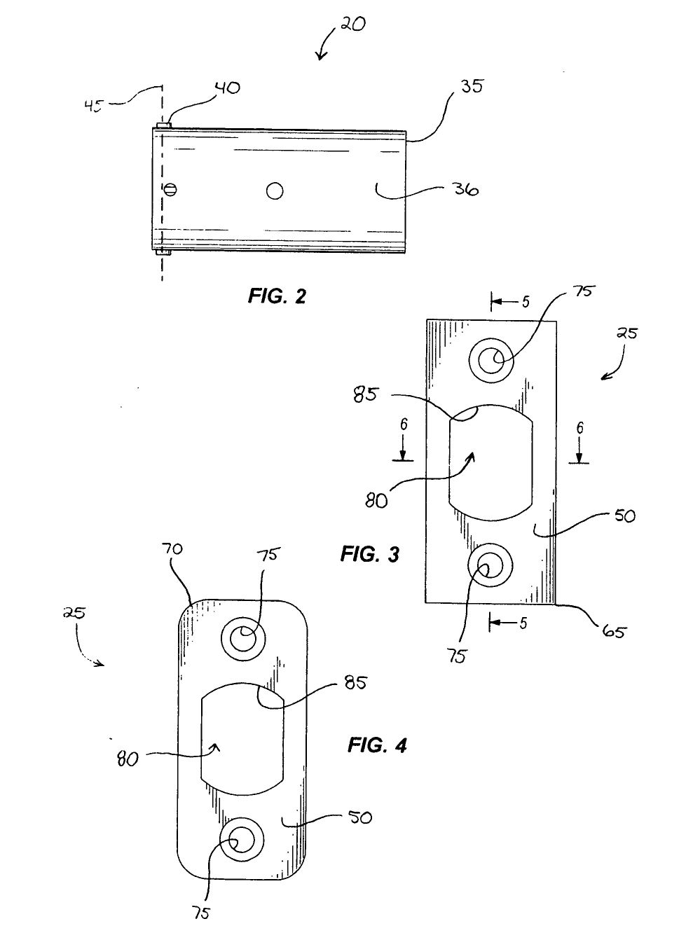

FIGS. 1 and 2 illustrate the housing 20 that includes a wall 35 defining an outer surface 36. The housing 20 is installed within the door using common attachment methods (e.g., screws, press fit, etc.). The wall 35 includes a cylindrical cross-section in the embodiment shown in FIGS. 1 and 2, although a rectangular cross-section is also possible. The wall 35 surrounds a portion of the latch 15 and may include a bias member (not shown) to force the latch 15 into an extended condition.

The housing 20 further includes first snap members disposed on the outer surface 36. In the embodiment shown in FIGS. 1 and 2, the first snap members are defined as snap features 40. The snap features 40 include projections having cylindrical cross-sections that protrude from the outer surface 36. Other embodiments of the snap features 40 may include projections having other cross-sections (e.g., rectangular, etc.). The snap features 40 are disposed in axially opposite directions defined by a vertical axis 45. Other constructions of the snap features 40 may include snap features disposed along an axis (not shown) other than along the vertical axis 45 (e.g., snap features horizontally or diagonally opposed, snap member separated by an angle less than 180 degrees, etc.). Still other constructions may include one snap feature 40 or more than two snap features.

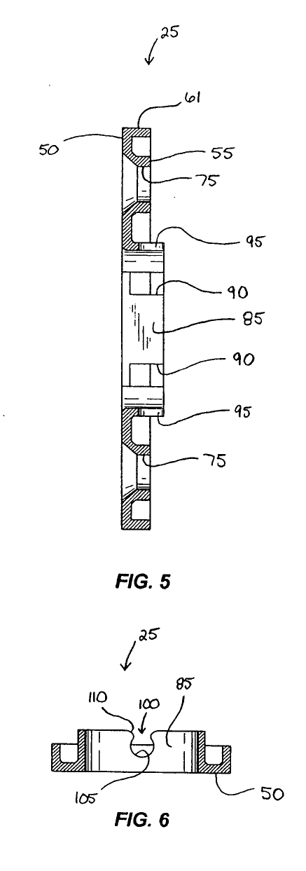

FIGS. 1 and 3-6 show one embodiment of the faceplate 25. The faceplate is defined by a first major surface 50, a second major surface 55 oppositely positioned from the first major surface 50, vertical sides 60, and horizontal sides 61. When the latch assembly 10 is assembled, the first major surface 50 is configured to face the door frame opposite the strike box, and the second major surface 55 is configured to face the housing 20. The vertical and horizontal sides 60, 61 define square corners 65, although other constructions of the faceplate 25 may include rounded or curved corners 70 (see FIG. 4).

The faceplate 25 further includes mounting holes 75, an aperture 80, and a curved wall 85. The mounting holes 75 are configured to receive common fasteners that are operable to secure the faceplate 25 to the door. The aperture 80 extends through the faceplate 25 and is in axial alignment with the axis 30. The latch 15 is at least partially disposed within the aperture 80 when the latch assembly 10 is fully assembled.

The curved wall 85 is disposed adjacent the aperture 80 and surrounds the aperture 80, and extends away from the second major surface 55. The curved wall 85 includes at least one slot 90. The embodiment shown in FIG. 1 includes two slots 90, although more than two slots may also be disposed on the curved wall 85. The slots 90 are disposed in a vertical portion of the curved wall 85 and are configured to receive a portion of the housing 20. The slots 90 are operable to support the housing 20 in the door and to transfer a bearing load from the latch 15 to the door via the faceplate 25.

The faceplate 25 further includes second snap members disposed adjacent the aperture 80. In the embodiment of FIGS. 1 and 3-6, the second snap members are defined as snap receivers 95. The snap receivers 95 are configured to receive the snap features 40 to attach the faceplate 25 to the housing 20, and include an opening 100 and a pocket 105. The opening 100 is defined by a width that is smaller than a width defined by the snap feature 40, and includes edges 110 adjacent the pocket 105 to permit entry of the snap feature 40 through the opening 100 and into the pocket 105. The illustrated embodiment shows the curved edges 110, although other configurations may include square edges (not shown). The pocket 105 is configured to receive a substantial portion of the snap feature 40, and is defined by a width that is larger than the snap feature 40 and the opening 100. The relationship between the widths of the snap feature 40, the opening 100, and the pocket 105 allow the snap receiver 95 to receive and secure the snap feature 40. Other constructions of the latch assembly 10 may include a reverse arrangement where snap receivers 95 are disposed on the housing 20 and the snap features 40 are disposed on the faceplate 25. Still other constructions may include a faceplate having a channel adjacent the aperture 80 to allow the snap feature 40 disposed on the housing to pass at least partially through the channel prior to attachment with the snap receiver 95.

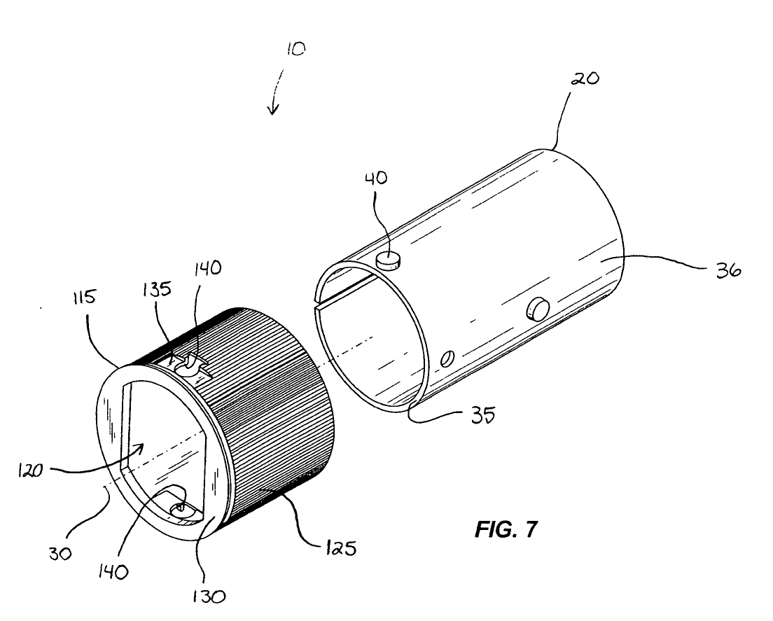

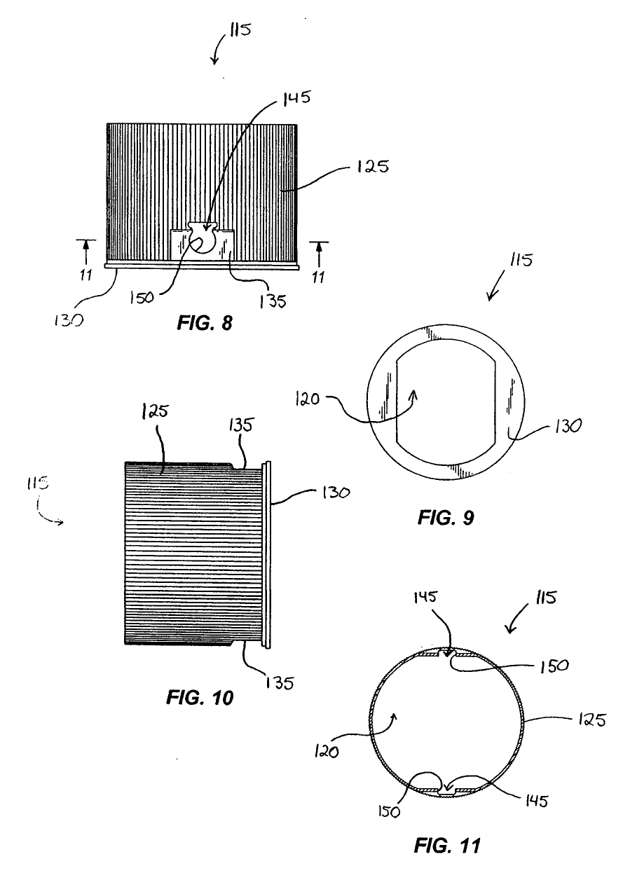

FIGS. 7-11 show another embodiment of a faceplate 115 for the door latch assembly 10. The illustrated faceplate 115 in FIGS. 7-11 is a circular drive-in plate. The faceplate 115 includes a circular cross-section, an aperture 120, and an exterior surface 125 having a plurality of ridges. The faceplate 115 is configured to attach to and at least partially support the housing 20. The aperture 120 is similar to the aperture 80 defined with regard to FIGS. 1-6 and will not be discussed in detail.

The faceplate 115 further includes a major surface 130, recessed surfaces 135, and snap members. The recessed surfaces 135 are disposed adjacent the major surface 130 and include a substantially flat surface or groove cut into the exterior surface 125 to partially define the snap receivers 140.

The snap members shown in FIGS. 7-11 are defined as snap receivers 140. The snap receivers 140 are configured to receive the snap features 40, and each snap receiver 140 includes an opening 145 and a pocket 150. The opening 145 and the pocket 150 are similar to the opening 100 and the pocket 105 such that the snap receivers 140 are operable to receive and secure the snap features 40. Other constructions of the latch assembly 10 may include snap receivers (not shown) that are disposed on the housing 20 and snap features (not shown) that are disposed on the faceplate 115 to facilitate attachment of the faceplate 115 to the housing 20.

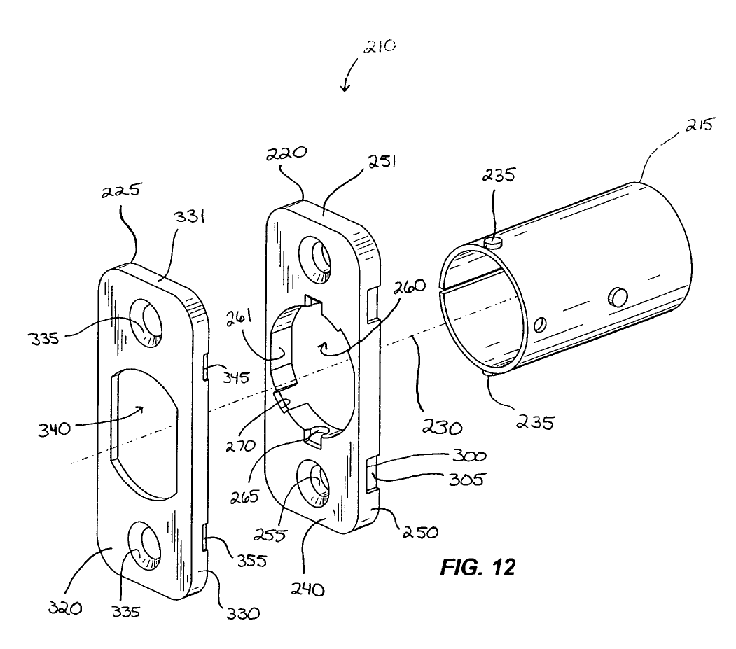

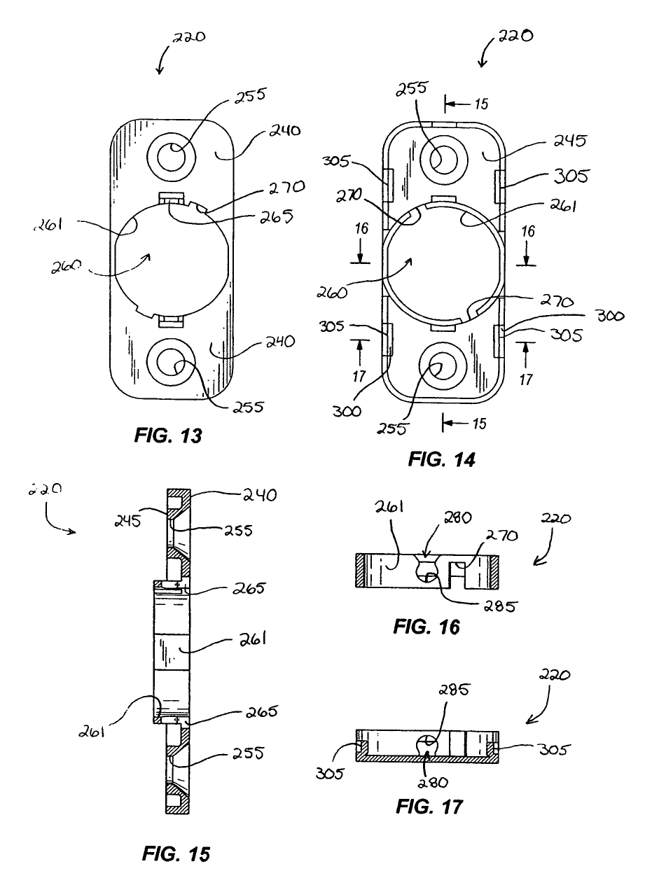

FIGS. 12-21 show another embodiment of a door latch assembly 210 that includes a housing 215, a backplate 220, and a plate or faceplate 225. The housing 215 includes an axis 230 and first snap members or snap features 235 that are similar to the snap features 40 described with regard to FIGS. 1-11 and will not be discussed in detail.

FIGS. 12-17 illustrate the backplate 220 that is defined by a first major surface 240, a second major surface 245 oppositely positioned from the first major surface 240, vertical sides 250, and horizontal sides 251. When the latch assembly is assembled, the first major surface 240 is configured to face the faceplate 225 and the second major surface 245 is configured to face the housing 215.

The backplate 220 includes mounting holes 255 and an aperture 260. The mounting holes 255 are configured to receive common fasteners, similar to the mounting holes 75 described with regard to FIGS. 1 and 3-6. The aperture 260 extends through the backplate 220 and is in axial alignment with the axis 230 to receive a portion of a latch (not shown) similar to the latch 15. The aperture 260 includes an outer perimeter 261. The outer perimeter 261 is operable to engage a portion of the housing 215 and is operable to at least partially support the housing 215 in the door and to transfer a bearing load from the latch to the door.

The backplate 220 shown in FIGS. 12-17 further includes second snap members defined as snap receivers 265 and channels 270. The snap receivers 265 and the channels 270 are disposed within an outer perimeter 275 of the aperture 260. Each of the snap receivers 265 includes an opening 280 adjacent the first major surface 240 and a pocket 285 configured to receive the snap features 235 and to attach the backplate 220 to the housing 215. The snap receivers 265 extend from the first major surface 240 toward the second major surface 245. The opening 280 and the pocket 285 are similar to the openings 100, 145 and the pockets 105, 150 described above such that the snap receivers 265 are operable to receive and to secure the snap features 235. Other constructions of the backplate 220 may include one or more than two snap receivers 235. Still other constructions may include the snap receivers 265 extending from the second major surface 245 toward the first major surface 240.

The channels 270 extend through the backplate substantially parallel with the axis 230. The channels 270 are offset from the snap receivers 265 so that interference between the snap receivers 265 and the channels 270 is avoided. The channels include a rectangular cross-section, although other cross-sections are possible (e.g., circular cross-sections, arc cross-sections, etc.) and considered herein. The channels are configured to allow the snap features 235 to pass through the backplate 220 and beyond the first major surface 240.

The vertical and horizontal sides 250, 251 define rounded comers, although other constructions of the backplate 220 may include square comers. The vertical sides 250 shown in the embodiments of FIGS. 12-17 include third snap members defined as outer snap receivers 300. Each of the outer snap receivers 300 is defined by a portion of the vertical side 250 and a recessed surface 305. The recessed surface 305 is disposed inward from the vertical sides 250 a first distance. In some constructions, the vertical sides 250 and the recessed surface 305 are connected by a third surface (not shown) orthogonal to the vertical sides 250 and the recessed surface 305. In other constructions, a gap (not shown) may be disposed between the vertical sides 250 and the recessed surface 305. In the embodiment shown in FIGS. 12-17, there are two outer snap receivers 300 disposed on the backplate 220. Other embodiments may include one or more than two outer snap receivers 300. Still other embodiments of the backplate 220 may include the outer snap receivers 300 oppositely disposed on the horizontal sides 251.

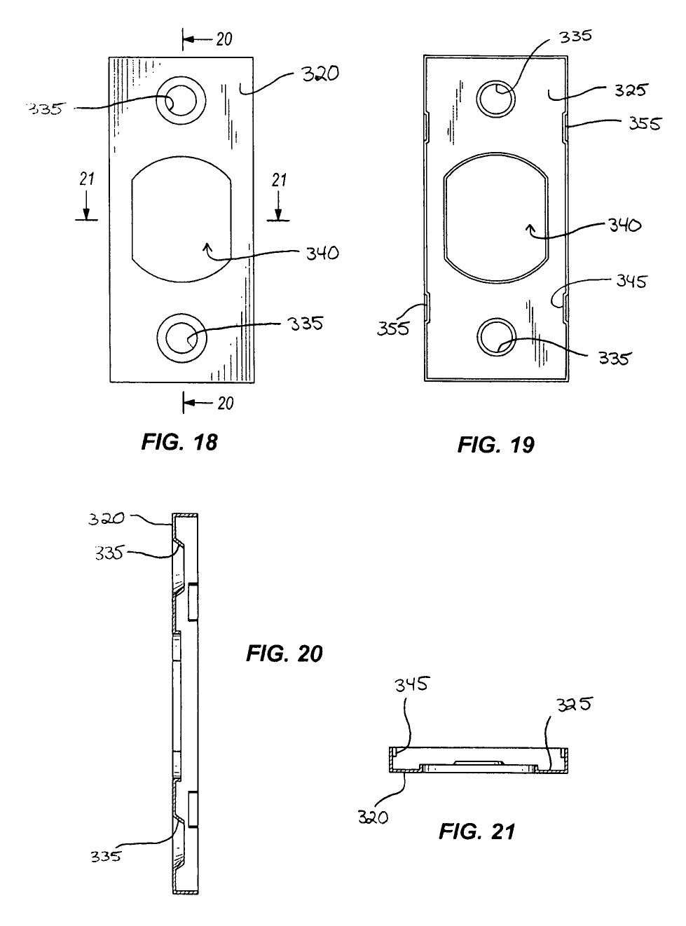

FIGS. 18-21 illustrate the faceplate 225 that is defined by a first major surface 320, a second major surface 325 oppositely positioned from the first major surface 320, vertical sides 330, and horizontal sides 331. The first major surface 320 is configured to face the strike box and the second major surface 325 is configured to face the backplate 220. The vertical and horizontal sides 330, 331 define corners that are rounded (see FIG. 12), although other constructions of the faceplate 225 may define comers that are square (see FIGS. 18-21).

The faceplate 225 includes mounting holes 335, an aperture 340, and fourth snap members disposed adjacent vertical sides 330. The mounting holes 335 are configured to receive fasteners and are similar to the mounting holes 75, 255 described above and will not be discussed in further detail. The aperture 340 extends through the faceplate 225 and is in axial alignment with the axis 230 to receive a portion of the latch.

The embodiment of FIGS. 12 and 18-21 show the fourth snap members defined as outer snap features 345. Each of the outer snap features 345 is defined by a portion of the vertical side 330 and a recessed surface 355. The recessed surface 355 is disposed inward from the vertical sides 330 a second distance. In some constructions, the vertical sides 330 and the recessed surface 355 are connected by a third surface (not shown) orthogonal to the vertical sides 330 and the recessed surface 355. In other constructions, a gap (not shown) may be disposed between the vertical sides 330 and the recessed surface 355. The second distance is defined such that to be less than the first distance to allow the outer snap features 345 to snap into the outer snap receivers 300. In the embodiment shown in FIGS. 12 and 18-21, there are two outer snap features 345 disposed on the faceplate 225. Other embodiments of the faceplate 225 may include the outer snap features 345 oppositely disposed on the horizontal sides 331 when the outer snap receivers 300 are similarly disposed on the horizontal sides 251. In still other embodiments, the outer snap receivers 300 may be disposed on the faceplate 225 and the outer snap features 345 may be similarly disposed on the backplate 200.

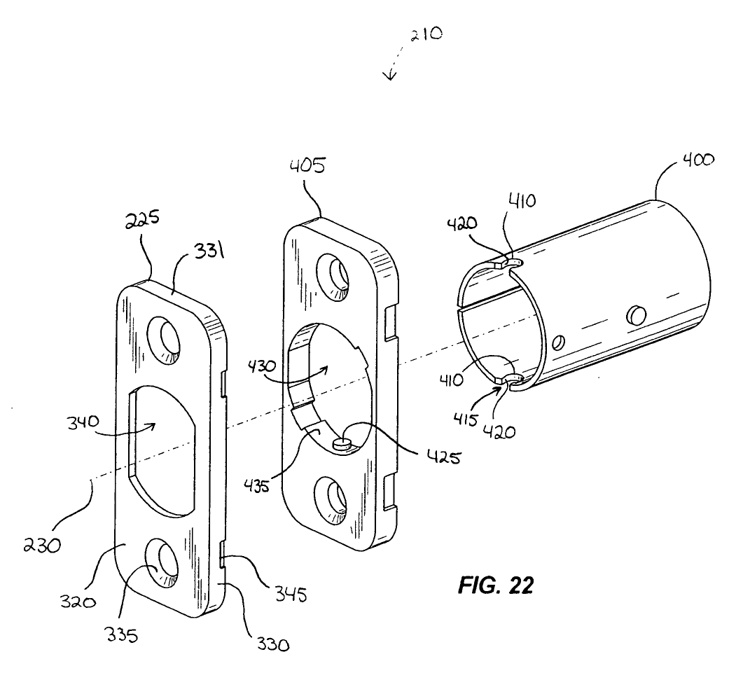

FIG. 22 shows alternative embodiments of a housing 400 and a backplate 405 for the door latch assembly 210. The housing 400 is similar to the housings 20, 215 described above, except that the housing 400 includes snap receivers 410 in place of the snap features 40, 235 described with regard to FIGS. 1-21. The snap receivers 410 are similar to the snap receivers 95, 140, 265 and include an opening 415 and a pocket 420 disposed adjacent an end of the housing 400.

The backplate 405 shown in FIG. 22 is similar to the backplate 220 described with regard to FIGS. 12-21, except that the backplate 405 includes snap features 425 in place of the snap receivers 265 on the backplate 220, and further includes an aperture 430. The snap features 425 are similar to the snap features 40, 235 already described, and protrude from an outer perimeter 435 of the aperture 430. The snap receivers 410 are configured to receive the snap features 425 and to attach the backplate 405 to the housing 400 in a manner that is opposite the attachment of the backplate 220 to the housing 215. As described above, the relationship between the widths of the snap receiver 410 and the snap feature 425 allow the snap feature 425 to snap into the snap receiver 410.

To attach the faceplate 25, 115 to the housing 20 as described with regard to FIGS. 1-11 without using a tool (e.g., screw driver, hammer, etc.) or a tool-driven fastener, the aperture 80 is aligned with the axis 30. The first snap member having at least one of the snap features 40 and the snap receivers 95, 140 is then aligned with the second snap member having the other of the snap features 40 and the snap receivers 95, 140. Attachment of the faceplate 25, 115 further includes inserting at least one of the first snap member and the second snap member into the other of the first snap member and the second snap member. The opening 100 flexes in response to insertion of the snap feature 40 into the snap receiver 95, 140, securing the snap feature 40 at least partially within the snap receiver 95 in a snap arrangement. Further, the slots 90 receive a portion of the housing 20 to provide support for latch 15 and the housing 20. The slots 90 transfer a bearing load from the housing 20 to the faceplate 25, 115 to provide additional strength to the door latch assembly 10. In this manner, the faceplate 25, 115 supports the housing 20 to evenly distribute the load on the door latch assembly 10.

Once the faceplate 25, 115 is attached to the housing 20, the faceplate 25, 115 must be aligned with a surface (not shown) of the door such that the faceplate 25, 115 is substantially flush with the surface. In one construction, the faceplate 25, 115 is rotated such that the snap feature 40 rotates within the snap receiver 90, 140 about the vertical axis 45 to align the faceplate 25, 115 with the surface. In other constructions, the faceplate 25, 115 may be aligned with the surface using clearance between the snap feature 40 and the snap receiver 95, 140.

The faceplate 25, 115 disengages from the housing 20 by disengaging one of the first snap member and the second snap member from the other of the first snap member and the second snap member without using a tool. The faceplate 25, 115 is pulled such that a force is applied substantially along the axis 30 to disengage the snap feature 40 from the snap receiver 90, 140. If the faceplate 25, 115 is replaced by a second faceplate (not shown), a third snap member (not shown) disposed on the second faceplate that is similar to the second snap member is aligned with the first snap member. The second faceplate then attaches to the housing 20 in a manner similar to the method described above.

The faceplate 225 of the embodiments described with regard to FIGS. 12-21 is attached to the housing 215 by attaching the backplate 220 to the housing 215 and attaching the faceplate 225 to the backplate 220. Some constructions may include attaching the faceplate 225 to the backplate 220 prior to attaching the backplate 220 to the housing 215. Other constructions may include attaching the backplate 220 to the housing 215 prior to attaching the faceplate 225 to the backplate 220.

The backplate 220 is attached to the housing 215 by aligning the aperture 260 with the axis 230 and attaching the backplate 220 to the housing 215 without using a tool by aligning the first snap member with the second snap member, and inserting one of the first snap member and the second snap member having the snap feature 235, 425 into the other of the first snap member and the second snap member having the snap receiver 265, 410. In one construction, the alignment of the first and second snap members further requires rotating the backplate 220 about the axis 230 in a first direction, aligning the channels 270 with the first snap members, passing the first snap members through the channels 270 such that the first snap members extend at least partially beyond the first major surface 240, and rotating the backplate 220 about the axis 30 in a second direction to align the first snap members with the second snap members. The opening 415 flexes in response to insertion of the snap feature 235, 425 into the snap receiver 265, 410 to secure the snap feature 235, 425 at least partially within the snap receiver 265, 410.

Attachment of the faceplate 225 to the backplate 220 includes aligning the third snap member with the fourth snap member and inserting one of the third snap member and the fourth snap member having the outer snap feature 345 at least partially into the other of the third snap member and the fourth snap member having the outer snap receiver 300.

Once the faceplate 225 is attached to the housing 215, the faceplate 225 is aligned with a surface of the door by rotating the faceplate 225, while attached to the backplate 220 and the housing 215, such that the snap feature 345 rotates within the snap receiver 300 to align the faceplate 225 with the surface. In other constructions, the faceplate 225 may be aligned with the surface using clearance between the snap feature 235, 425 and the snap receiver 300.

The faceplate 225 disengages from the housing 215 by applying a force to the faceplate 225 substantially along the axis 230 to disengage one of the third snap member and the fourth snap member from the other of the third snap member and the fourth snap member without using a tool. If the faceplate 225 is replaced by a second faceplate (not shown), a fifth snap member (not shown) disposed on the second faceplate that is similar to the fourth snap member is aligned with the third snap member. The second faceplate is then attached to the housing 215 as described above with regard to the faceplate 225.

The backplate 220 disengages from the housing 215 by applying a force to the backplate 220 substantially along the axis 230 to disengage one of the first snap member and the second snap member from the other of the first snap member and the second snap member without using a tool. If the backplate 220 is replaced by a second backplate (not shown), a sixth snap member (not shown) disposed on the second backplate that is similar to the second snap member is aligned with the first snap member. The second backplate is then attached to the housing 215 as described above with regard to the backplate 220.

The snap arrangement between the first snap member and the second snap member allows efficient, uncomplicated attachment and removal of the faceplate 25, 115, 225 and the housing 20, 215, 400 without the need for additional tools or specialized assembly equipment. In the embodiments including the housing 215, 405, the backplate 220, 405, and the faceplate 225, the third snap members and the fourth snap members provide a second snap arrangement that facilitates efficient attachment and removal of the faceplate 225 and the backplate 220, 405 without the use of tools.

Thus, the invention provides, among other things, a plate for a door latch assembly that is attachable to a housing of the door latch assembly without using tools. Various features and advantages of the invention are set forth in the following claims.

What is claimed is:

1. A faceplate for a door latch assembly that includes a housing and a latch disposed within the housing, the housing having a first snap member, the faceplate comprising:
a first major surface;
a second major surface oppositely positioned from the first major surface;
side portions disposed adjacent the first and second major surfaces;
an aperture disposed laterally through the first and second major surfaces and configured to allow the latch to extend laterally through the faceplate; and
a second snap member disposed on the faceplate to couple with the first snap member and to attach the faceplate to the housing without the use of a tool.

2. The faceplate of claim 1, wherein the second snap member includes at least one of a snap feature and a snap receiver adapted to couple with the second snap member having the other of the snap feature and the snap receiver disposed on the housing.

3. The faceplate of claim 2, wherein the snap feature includes a width that is larger than a width of the snap receiver, and wherein the snap feature is configured to snap into the snap receiver.

4. The faceplate of claim 2, wherein the snap feature is configured to snap into attachment with the snap receiver.

5. The faceplate of claim 2, wherein the snap feature includes a projection, and wherein the snap receiver includes an opening and a pocket configured to receive the projection.

6. The faceplate of claim 1, further including at least one channel adjacent the aperture and configured to allow the first snap member to pass at least partially through the faceplate.

7. The faceplate of claim 6, wherein the first snap member is adapted to couple with the second snap member after passing at least partially through the faceplate.

8. The faceplate of claim 7, wherein the first snap member is a snap feature and the second snap member is a snap receiver.

9. The faceplate of claim 1, further including at least one wall disposed adjacent the aperture, wherein the at least one wall includes at least one slot configured to receive a portion of the housing.

10. The faceplate of claim 9, wherein the at least one slot is operable to transfer a bearing load from the housing to the faceplate and to strengthen the door latch assembly.

11. A door latch assembly installed in a door, the door latch assembly comprising:
a housing defining a space and including a first snap member;
a latch at least partially disposed within the space;
a faceplate including a second snap member and an aperture to receive a portion of the latch, the faceplate coupled to the housing through the first and second snap members without the use of a tool.

12. The door latch assembly of claim 11, wherein the first snap member is directly coupled with the second snap member in a snap arrangement.

13. The door latch assembly of claim 11, wherein the first snap member includes at least one of a snap feature and a snap receiver, and wherein the second snap member includes at least one of the other of the snap feature and the snap receiver.

14. The door latch assembly of claim 13, wherein the snap feature includes a projection, and wherein the snap receiver includes an opening and a pocket to receive the snap feature.

15. The door latch assembly of claim 14, wherein the snap feature includes a width that is larger than a width of the snap receiver, and wherein the snap feature is configured to snap into the snap receiver.

16. The door latch assembly of claim 11, further including at least one wall disposed adjacent the aperture and having at least one slot configured to receive a portion of the housing, and wherein the at least one slot is operable to transfer a bearing load from the housing to the faceplate and to strengthen the door latch assembly.

17. The door latch assembly of claim 11, further including a backplate having a third snap member, a fourth snap member, and a second aperture to receive a portion of the latch.

18. The door latch assembly of claim 17, wherein the housing couples with the backplate through the first snap member and the third snap member, and wherein the backplate couples with the faceplate through the second snap member and the fourth snap member.

19. The door latch assembly of claim 18, wherein the first snap member includes at least one of a snap feature and a snap receiver, and wherein the third snap member includes at least one of the other of the snap feature and the snap receiver.

20. The door latch assembly of claim 19, wherein the second snap member includes at least one of an outer snap feature and an outer snap receiver, and wherein the fourth snap member includes at least one of the other of the outer snap feature and the outer snap receiver.

21. The door latch assembly of claim 20, wherein the snap receiver is configured to receive the snap feature in a snap arrangement, and wherein the outer snap receiver is configured to receive the outer snap feature in a second snap arrangement.

22. The door latch assembly of claim 18, wherein the backplate further includes at least one channel to allow the first snap member to pass at least partially through the backplate.

23. The door latch assembly of claim 18, wherein one of the first snap member and the third snap member is operable to rotate about an axis defined by the other of the first snap member and the third snap member, and wherein the faceplate is configured to rotate about the axis and to align with a surface of the door.

24. The door latch assembly of claim 18, further including at least one wall disposed adjacent the second aperture and having at least one slot configured to receive a portion of the housing, and wherein the at least one slot is operable to transfer a bearing load from the housing to the backplate and to strengthen the door latch assembly.

25. A method of attaching a faceplate for a door latch assembly having a housing and a latch disposed within the housing and installed in a door, the method comprising:
aligning an aperture of the faceplate with an axis defined by the housing; and
attaching the faceplate to the housing without using a tool.

26. The method of claim 25, further including aligning a first snap member defined by the housing with a second snap member defined by the faceplate.

27. The method of claim 26, wherein attaching the faceplate to the housing further includes
inserting one of the first snap member and the second snap member into the other of the first snap member and the second snap member;
flexing one the first snap member and the second snap member; and
securing one of the first snap member and the second snap member at least partially within the other of the first snap member and the second snap member.

28. The method of claim 27, further including aligning the faceplate with a surface of the door.

29. The method of claim 28, wherein aligning the faceplate includes rotating the faceplate about a vertical axis defined by the first snap member.

30. The method of claim 26, further including
disengaging one of the first snap member and the second snap member from the other of the first snap member and the second snap member by applying a force to the faceplate substantially along the axis;
removing the faceplate from the housing;
aligning a third snap member defined by a second faceplate with the first snap member; and
attaching the second faceplate to the housing.

31. The method of claim 25, further including
confining the latch within at least one sidewall of the faceplate; and
transferring a bearing load from the latch to the door through the at least one sidewall to strengthen the door latch assembly.

32. The method of claim 25, further including,
aligning an aperture of a backplate with the axis;
attaching the backplate to the housing without using a tool;
aligning the faceplate with the backplate; and
attaching the faceplate to the backplate.

33. The method of claim 32, wherein attaching the backplate to the housing further includes
aligning a first snap member defined by the housing with a second snap member defined by the backplate; and
inserting one of the first snap member and the second snap member at least partially into the other of the first snap member and the second snap member.

34. The method of claim 33, wherein aligning the first member with the second snap member further includes
rotating the backplate about the axis in a first direction;
aligning a channel defined by the backplate with the first snap member;
passing the first snap member through the channel such that the first snap member extends at least partially beyond the backplate; and
rotating the backplate about the axis in a second direction.

35. The method of claim 33, wherein attaching the faceplate to the backplate further includes
aligning a third snap member defined by the backplate with a fourth snap member defined by the faceplate; and
inserting one of the third snap member and the fourth snap member at least partially into the other of the third snap member and the fourth snap member.

36. The method of claim 32, further including aligning the faceplate with a surface of the door.

37. The method of claim 36, wherein aligning the faceplate includes rotating the faceplate about a vertical axis defined by the first snap member.

38. The method of claim 33, further including
disengaging the first snap member from the second snap member by applying a force to the backplate substantially along the axis;
removing the backplate from the housing;
aligning a third snap member defined by a second backplate with the first snap member; and
attaching the second backplate to the housing.

39. The method of claim 34, further including
disengaging the fourth snap member from the third snap member by applying a force to the faceplate substantially along the axis;
removing the faceplate from the backplate;
aligning a fifth snap member defined by a second faceplate with the third snap member; and
attaching the second faceplate to the backplate.

40. The method of claim 32, further including
confining the latch within at least one sidewall of the backplate; and
transferring a bearing load from the latch to the door through the at least one sidewall to strengthen the door latch assembly.
